(19) United States
(12) Patent Application Publication
(10) Pub. No.: US 2009/0055358 A1
(43) Pub. Date: Feb. 26, 2009

(54) EFFICIENT PROCESSING OF MAPPED BOOLEAN QUERIES VIA GENERATIVE INDEXING

(76) Inventor: Anthony Tomasic, Pittsburgh, PA (US)

Correspondence Address: COHEN & GRIGSBY, P.C., 625 LIBERTY AVENUE, PITTSBURGH, PA, 15222-3152, US

(21) Appl. No.: 12/190,894

(22) Filed: Aug. 13, 2008

Related U.S. Application Data
(60) Provisional application No. 60/955,481, filed on Aug. 13, 2007.

(51) Int. Cl. G06F 17/30

(52) U.S. Cl. 707/3; 707/E17.076

(57) ABSTRACT

A computer assisted method of searching at least one corpus of information based on at least one query. The method includes creating a generative index based on the corpus and a mapping of terms of the query to terms of the corpus. The method also includes searching the generative index and the corpus with the query to create a result comprising a portion of the corpus, wherein the result satisfies the query.

### CROSS REFERENCE TO RELATED APPLICATION

The present application claims priority to U.S. Provisional Patent Application No. 60/955,481 filed Aug. 13, 2007.

### BACKGROUND

The use of indexing to improve the performance of searches has been used successfully in computer science applications. Indexing trades the cost of building an index over data against an improvement in search performance. Given that searches are performed many times for each build of an index, the trade off works very well in many applications.

Different indexes give different costs for building an index and different search performance improvements. A successful instance of indexing for disk operations is the B-tree and its variants (e.g., R. Bayer and E. M. McCreight, Organization and Maintenance of Large Ordered Indexes, Acta Informatica 1, 173-189, 1972). Information retrieval systems generally use inverted indexes (e.g., Justin Zobel and Alistair Moffat, Inverted Files for Text Search Engines, ACM Computing Surveys, Vol. 38, No. 2, Article 6, July 2006). More recent work focuses on building indexes to improve the performance of specific operations. An example in this area uses q-grams (short character sequences) to improve the performance of approximate matching (e.g., L. Gravano, P. Ipeirotis, H. V. Jagadish, N. Koudas, S. Muthulrishnan, and D. Srivastava, Approximate String Joins in a Database (Almost) for Free, Proceedings of the 27th International Conference on Very Large Data Bases, 2001).

### SUMMARY

In one general aspect, embodiments of the present invention are directed to a computer assisted method of searching at least one corpus of information based on at least one query. The method includes creating a generative index based on the corpus and a mapping of terms of the query to terms of the corpus. The method also includes searching the generative index and the corpus with the query to create a result comprising a portion of the corpus, wherein the result satisfies the query.

Those and other details, objects, and advantages of the present invention will become better understood or apparent from the following description and drawings showing embodiments thereof.

### BRIEF DESCRIPTION OF THE DRAWINGS

Various embodiments of the present invention are described herein by way of example in conjunction with the following figures, wherein:

FIG. 1 illustrates a flowchart of an embodiment of a process for context-based machine translation;

FIG. 2 illustrates a flowchart of an embodiment of the generate index process of FIG. 1;

FIG. 3 illustrates a flowchart of an embodiment of the process query procedure of FIG. 1; and

FIG. 4 illustrates an embodiment of a system in which embodiments of the present invention may be used.

### DESCRIPTION

In general, various embodiments of the present invention are directed to systems and methods of mapping Boolean queries using a mapping to pre-compute possible matches as part of an index structure. Embodiments of the invention may be used to increase the performance of searching in the case when there is a mapping of symbols between a source query language and a target query language. Embodiments may be employed in machine translation where the source query language is, for example, English, the target language is, for example, Spanish and the mapping is the dictionary definitions of words. Embodiments of the invention may be used in bioinformatics in which the source language is, for example, protein sequences, the target language is, for example, protein sequences and the mapping is the scoring matrix of sequence-to-sequence comparisons.

Boolean set queries are a form of query processing that occurs in many computer science application domains: machine translation, information retrieval, bioinformatics, etc. Mapped Boolean set queries are an extension to Boolean set queries where a mapping function maps between the application domain and Boolean set queries. Various embodiments of the invention reduce query processing time of mapped Boolean queries by pre-computing possible matches as part of an index structure to produce very fast query processing are described herein. The circumstances under which pre-computing is effective are also described herein. Further, experimental results that demonstrate cost effectiveness of embodiments of the invention are described herein. Boolean set query processing is described hereinbelow. A database consists of a set of facts of the form:

{{id₁ T_{1,1} T_{1,2} . . . T_{1,h}, D₁} {id₂ T_{2,1} T_{2,2} . . . T_{2,j}, D₂} . . . {idₙ T_{n,1}, T_{n,2} . . . T_{n,k}, Dₙ}}

where id is a unique identifier of the fact, T_{i,1} T_{i,2} . . . T_{i,h} is a sequence of terms and Dᵢ is a data record. An identifier is an integer. A term is an atomic symbol which may be a word or a phrase. A data record consists of a set of attribute/value pairs. For example {1 “I love” “ice cream” {<frequency, 100>}} is a fact with identifier 1, the sequence of two phrases “I love” and “ice cream” and a data record with a single attribute frequency and a single value 100 for that attribute.

A Boolean set query (or query) in conjunctive normal form has the form:

{{T_{1,1} T_{1,2} . . . T_{1,h}} {T_{2,1} T_{2,2} . . . T_{2,j}} . . . {T_{n,1} T_{n,2} . . . T_{n,k}}}

The following definitions apply herein:

Set: A group of Terms (e.g., {T_{1,1}, T_{1,2} . . . T_{1,h}}) is a “Set of Terms” or “Set”. Each Set of Terms such as {T_{1,1} T_{1,2} . . . T_{1,h}} is interpreted as a disjunction of Terms.

Query: A group of Sets is a “Query” (e.g., {{T_{1,1} T_{1,2} . . . T_{1,h}} {T_{2,1} T_{2,2} . . . T_{2,j}} . . . {T_{n,1} T_{n,2} . . . T_{n,k}}}. The entire Query is interpreted as a conjunction of Sets.

Result: The set of facts that satisfy the query.

For example, in information retrieval, the query “(information OR database) AND retrieval” is written: {{information database} retrieval}. The result of this query is the set of facts that contain the terms “information” and “retrieval” or “database” and “retrieval”.

Boolean set queries are classically processed in two steps, indexing and query processing. For indexing, the set of facts are indexed using an inverted file. Query processing is performed by intersection of inverted lists (for conjunction operations) and union of inverted lists (for disjunction operations). Query processing time cost is on the order of the sum of the lengths of the inverted lists of the terms that appear in the query. Query processing space cost is on the order of the size of the query result.

Mapped Boolean set queries are described hereinbelow. In some applications, there is a mapping between the application domain and the set database. Queries are issued in the language of the application domain. The queries are mapped into the Boolean set query database domain. The query is then processed as described hereinabove. The answer is then mapped back into the application domain. Thus, the application domain also has a query language and a result set.

For example, in the context-based machine translation (CBMT) application domain, a source sentence is transformed into a series of application queries. Each application query is then transformed into a Boolean set query. The results of the series of Boolean set queries are then analyzed to generate the target translation sentence.

Application query: Application queries are referred to herein as an unmapped conjunctive query with the form:

{S₁ S₂ . . . Sₛ}

where S₁ S₂ . . . Sₛ is an unordered set of source language terms or phrases. Disjunctive application queries may be handled by rewriting the disjunction application query to be a set of unmapped conjunctive queries. Each unmapped conjunctive query is processed and the results are unioned together in the classical manner.

Mapping: A mapping D is a function that takes source language terms or phrases and returns the corresponding set of possible target terms.

D(Sᵢ)→{T_{i,1} T_{i,2} . . . T_{i,h}}

That is, the mapping generates a disjunction of terms. A term is a target language content word or phrase. The (partial) inversion of the mapping is denoted D⁻¹.

Mapped conjunctive query: A mapped conjunctive query is a Boolean query produced by replacing every source language term or phrase in an unmapped conjunctive query with the result of the mapping function. A mapped conjunctive query has the form {{T_{1,1} T_{1,2} . . . T_{1,h}}, {T_{2,1} T_{2,2} . . . T_{2,i}} . . . {T_{n,1} T_{n,2} . . . T_{n,j}}}

For example, the Spanish language sentence “Yo amo el sorbete” (“I love ice cream”) can be expressed as the unmapped conjunctive query of length 4: {“Yo” “amo” “el” “sorbete”}. Given the mapping {“Yo”→{“I”}, “amo”→{“I love”, “love”, “master”}, “el”→{“the”}, “sorbete”→“ice cream”}, the corresponding mapped conjunctive query is: {{“I”} {“love” “I love” “master”} {“the”} {“ice cream”}}. In traditional Boolean set processing, this query is executed against an inverted indexed database. The result, in a database containing English n-grams, might be “I love the ice cream” and “I master the ice cream”. Note that the correct phrase, “I love ice cream” would not be retrieved. Solutions to this problem are discussed below.

The query processing of mapped conjunctive queries can be improved by generative indexing. Like classical query processing with an inverted index, generative indexing consists of an indexing phase and a corresponding query processing phase. For indexing, consider a given fact in the database. This fact will appear in the result of an unmapped conjunctive query iff each term in the fact is in the mapping range of at least one term in the mapping domain of an unmapped conjunctive query term. Generative indexing uses this fact to construct a generative index of the database. The generative index is an inverted index constructed over an inverse mapping of every fact in the database.

Generative Index: Formally, the generative index I is construct by, for each fact, identified by id, of the form {id T₁ T₂ . . . Tₖ, D₁}, inserting into an inverted index the union u of the inverse mapping of all terms: union(D⁻¹(T₁), D⁻¹(T₂), . . . D⁻¹(Tₖ)) for fact id.

For example, given the mapping {“Yo”→{“I”}, “amo”→{“love”}, “sorbete”→{“ice cream”}, “el sorbete”→{“ice cream”}, the fact {1 “I” “love” “ice cream”, <frequency, 10>} generates the generative index entry {(“Yo” “amo” “sorbete” “el sorbete”), 1}.

Note that in the case that D⁻¹(Tᵢ) returns the empty set; the empty set is dropped as a consequence of the union operation. This choice for terms without inverses leads eventually to the retrieval of facts with additional terms. Other choices are described hereinbelow.

Processing unmapped conjunctive query. To process an unmapped conjunctive query {S₁ S₂ . . . Sₛ}, the following steps are performed:
1. Process the Boolean query{S₁ S₂ . . . Sₛ} on the generative index I using the classical algorithm.
2. Filter the results to contain facts of size k such that s=k. This second step is optional in various embodiments.
3. Join the resulting identifiers with the identifiers of the facts to retrieve the matching facts. This third step can be removed by indexing the facts directly.

This algorithm produces false positive. For example, consider the database that consists of the single fact (1 {“a”, “b”}). The mapping contains {a→{1,2}, b→{3}}. The generative index is ({1, 2, 3}, 1). The query {12} returns the single fact, and this is incorrect because the query makes no reference to 3. However, this result can be filtered out by noting that the term “b” does not inverse map to anything in the query. The algorithm for this filtering step is described hereinbelow.

Consider the cost trade off of generative indexing. The size of the database is d. Generative index construction is done through two steps, generation and sorting. The time (and space) required to generate each entry in the generative index is on the order of kz where k is the number of terms in a fact and z is the average size of D⁻¹. It is the product of the application of the inverse dictionary to terms in the database. This critical value is the index expansion factor μ=kz. The size of the index is then on the order of μd. The time for the sort step is logarithmic in the size of the index and thus is on the order of μd ln μd.

Many practical cases exist where the index expansion fact a is a small number and thus indexing time and the space cost is manageable; in particular if D and D⁻¹ approximate a one-to-one mapping.

Note that the join in query processing is performed by first performing the index lookup on relation I and loading the resulting a tuples into memory. Then, for each tuple, the indexed fact is looked up. Given an index on the facts, performance is approximately O(μkt)+O(a ln d) where k is the number of terms in the query, t is the average length of an inverted list that appears in an answer, and a is the answer size. This expression defines the average case query response time.

Index expansion factor and query processing performance are empirically and algorithmically described hereinbelow.

The end-to-end procedure required to use generative indexing for a corpus of raw text is described herein. The end-to-end indexing procedure consists of the following steps:

1. Process the raw text into a sequence of n-grams.

2. Sort the n-grams lexigraphically.

3. Collapse duplicate n-grams and generate a fact representing the n-gram and the frequency count. A language model may also be applied at this step.

4. Create the generative index. A language model may also be applied at this step.

5. Construct an inverted file on the generative index.

An end-to-end query procedure consists of the following steps:
1. Accept a query.
2. Issue the query to the generative index. A language model may also be applied at this step.
3. Join the retrieved index values with facts.
4. Check that each term in the retrieved fact corresponds to some term in the query. This step is optional, depending on application semantics.
5. Return as an answer the joined facts.

Because generative indexing relies directly on information retrieval technology, distribution of index construction and query processing is well understood.

Each extension to the basic method requires consideration of the impact on the generative index and on query processing.

In context-based machine translation (CBMT), each input sentence to be translated is processed with a sliding window of unmapped conjunctive queries, e.g., of length k. If the query returns the empty set as a result, the system issues a new query using the same sliding window, but of length k−1. This process continues until a non-empty result set is produced. In the case of the application of generative indexing to CBMT, the same technique is used. An empty query results produced by the processing of a mapped conjunctive query implies that the sliding window process interates by issuing a query of length k−1.

Handling empty inverse mappings. During the generation of a generative index, D⁻¹(T) may be empty for some particular T. There are several solutions to this problem. One solution throws out the fact in this case. This solution is relatively simple and decreases the size of the index. Another solution allows D⁻¹ to return the empty set for this case during index generation. In this solution, the fact is indexed as if T doesn't exist, and query processing returns the fact if the other terms of the fact satisfy the query. That is, extraneous terms will appear in result sets. A third solution returns T for D⁻¹(T). The T term is specially marked to indicate it is from the target language. With no other modification, this term can be delivered to the application program, thus allowing the application program to process the appearance of the term T in the result.

Efficient processing of modifications to the mapping. Generative indexing assumes that the mapping is static and leverages this fact to optimize index construction. Solutions to the problem of a dynamic mapping are discussed hereinbelow.

One solution uses the third empty dictionary solution presented hereinabove. Suppose a dictionary entry Sₜ for T is discovered after index time. Then the query {S₁ S₂ . . . Sₜ . . . Sₛ} can be modified to {S₁ S₂ . . . T . . . S_{S}} and the correct fact will be retrieved. This technique avoids re-indexing for every modification to the dictionary.

Another solution assumes that the source of dynamic dictionary modification is a rapid prototyping experimental environment. In this environment, the dictionary is partitioned into M sets. Each set is processed independently as usual. Then queries are issued in parallel to all M sets. The results are unioned. Modification to one of the sets in M rebuilds the generative index for that partition of the dictionary.

A third solution incrementally updates the generative index. To accomplish an incremental update, for an addition to the dictionary, every fact that has the matching range of the entry is fetched (via linea search or a traditional inverted index). Then, all generative index entries are modified by considering the pair of the fact and the dictionary addition. These entries are added incrementally to the index. The retrieval structure of the index must also be incrementally modified. For a deletion to the dictionary, the same procedure is run, but the corresponding generative index entries are modified and the retrieval structure is also incrementally modified.

Function words are frequently occurring terms in language applications of generative indexing. Function words are implemented as follows. First, a set of target language function words X is defined. X may be the most common words in the database. In addition, the set X⁻¹ of inverse terms is constructed as {y|x in X, y in D⁻¹(X)}. During indexing, any term in a fact that is in X is stripped before the generative index entry is constructed (equivalently, D⁻¹(T) returns the empty set). During query processing, the terms in X⁻¹ in an unmapped conjunctive query are also stripped.

Function words introduce a subtlety in query processing, because the length of the unmapped conjunctive query no longer matches the length of a fact. For example, the sentence “Yo amo el sorbete” is processed into the unmapped conjunctive query {“Yo” “amo” “sorbete”} because “el” is the inverse dictionary lookup of the function word “the”. This query matches the fact {“this” “is” “ice cream” “love”} because “this” and “is” and “I” are function words in English (the inverse of “I” is “Yo”, so X⁻¹ would contain “Yo”).

A second subtlety is the case where a word w in X⁻¹ translates to a word in X and a word not in X. In this case, the second word will never be matched because w is stripped from the unmapped conjunctive query. For example, the word “con” is the inverse of the function word “with”, but “con” also is the inverse of the content word “despite”. One solution is to eliminate all words with this property from the set X. Another solution issues two unmapped conjunctive queries, one with “con” stripped and the other without “con” stripped.

Stop list processing of the index for function words is essentially a simplistic linguistic model that restricts which combinations of unmapped conjunctive queries can match a fact. A second level of processing that would reduce the size of the index would introduce a model that predicts the likelihood of two unmapped terms co-occurring. Unlikely combinations are dropped. That is, given a corpus of statements in the source language, compute co-occurrence within a window of size k. Then, for each generated combination during index generation, compute the likelihood based on the data. Discard combinations less than some threshold likelihood. This index space performance improvement works best with larger n-grams where the expansion factor is higher (generating far more index entries) and thus the likelihood of generating a nonsense unmapped conjunctive query is higher.

Database phrases are multi-token terms T in the database such that D⁻¹(T) is non-empty. For example, D⁻¹ (“ice cream”)={“sorbete”}. This effect means that the match ngram will not have the same length as the unmapped conjunctive query. Note that a general space-time trade-off exists throughout generative indexing. For each functionality extension, an implementation exists on the query side and an implementation exists on the indexing side.

A solution to verb conjugation is to add all conjugation translations to the dictionary. Query phrases are handled by “flattening” the query phrase in the generated index. For example, consider the source sentence “a b” which is translated to the target “1”. The generative index of “1” is “a b”. This index will match the source query “a b”. The only issue is that the every part of the query phrase will match the target. Thus, the query “a” will also match. This problem can be handled in the same way as the false positive problem described hereinabove.

Relaxed matching, query side, is the property that additional unmatched terms may appear in the query. The implementation of relaxed match, query side, issues a query for each C(k, k−1) combination of terms in the unmapped conjunctive query. The performance impact would be significant, increasing the amount of work per query by k. (Note that it is assumed that all k terms occur in D⁻¹. It generally does not make sense to issue a query containing a term that is not in D⁻¹ because such a query will always return an empty result).

In various embodiments, two implementations may be used. The first implementation issues all k subsets simultaneously. The second implementation (using some source language statistics) orders the k terms from most rare to least rare, and issues a query with one term dropped in this order, until a match is found. The decision may rest on average latency for processing a query and the bound on this latency.

Another extension allows up to M content words to intrude. This extension is called related match, corpus side. Relaxed match, corpus side, is implemented by modified indexing. For a fact of size k, generate index entries for all C(k, k−M) combinations. The space cost of this implementation is k if M is 1. One could mark these indexes as part of a composite key index entry, if control at that level is desired. The impact on query performance would be O(ln k), essentially a constant factor because k is less than 11. Note that these performance estimates are over-estimates, because function words do not generate combinations in the generative indexing step.

Token matching is an extension where terms are replaced with class tokens. (For example, the term “Paris” in a fact or query is replaced with the token class “<city>”.) In token match it may be assumed that the source sentence can be preprocessed into the same classes as facts. For each fact generated, add to the data record any token match information required. Then, for each combination of additional token matches of the fact (typically only 1), generate an index entry with special class identifiers replacing the terms that are of the corresponding class. During query processing, recognize sentence tokens that belong to a class, and replace them with the corresponding special identifier of the class. Then, issue the query as normal. Editing of token classes may be handled in the same way as dictionary modification.

Another extension to generative indexing improves performance when multiple independent mappings are available for a database. For example, each mapping represents a difference language. For each new mapping, the generated index entries are added. Collusions with entries from other languages can be avoided by adding a type to each generative index entry representing the mapping that generated it. An advantage of merging indexes is that a single data structure handles multiple languages.

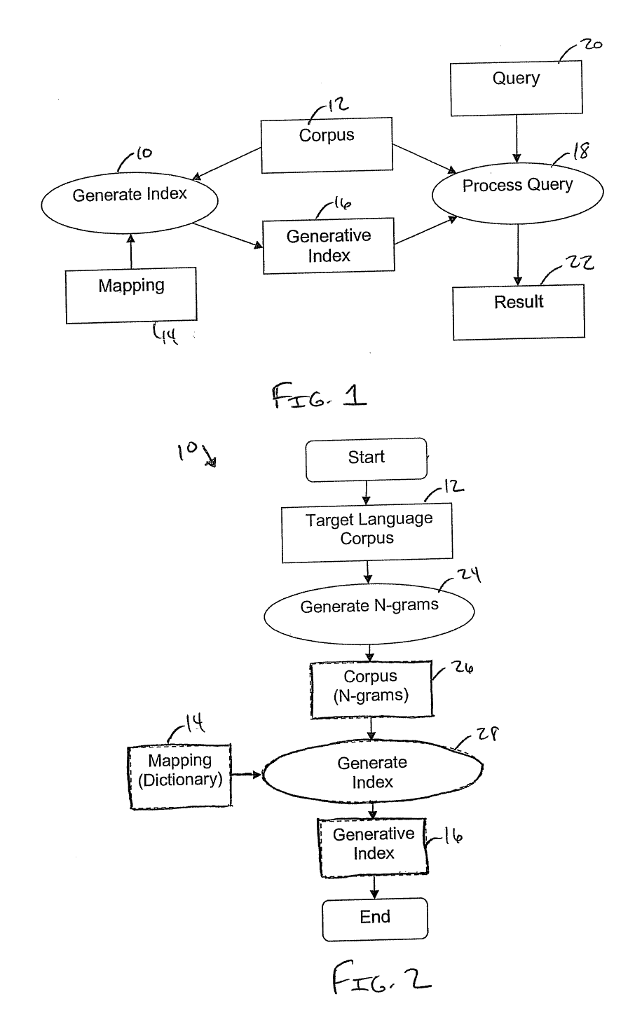

FIG. 1 illustrates a flowchart of an embodiment of a process for context-based machine translation. The process illustrated in FIG. 1 is a two phase process. In the first phase, a generate index process 10 takes a corpus of data 12 and a mapping 14 as input and generates a generative index 16 as output. In the second phase, a query process 18 takes a query 20, the generative index 16, and the corpus 12 as input and produces a result 22 as output.

FIG. 2 illustrates a flowchart of an embodiment of the generate index process 10 of FIG. 1. The target language corpus 12 is an input to a generate n-gram procedure 24. The output of the generate n-gram procedure 24 is a corpus 26 of n-grams with an occurrence count associated with each n-gram. The generate n-gram procedure 24 consists of the following steps in one embodiment:
1. Segment target language corpus into sentences
2. For each sentence, generate all sequential n-grams of length n, each thus consisting of n tokens
3. Sort all n-grams into a total ordering
4. Scan sorted n-grams and generate unique n-grams with a count of the occurrences of each unique n-gram

The n-gram corpus 26 and the mapping 14 (e.g., a dictionary that maps source query terms to target corpus terms) are inputs to a generate index process 28. The output of the generate index process 28 is the generative index 16. The generate index process 28 consists of the following steps in one embodiment:

1. For each input n-gram i, for each token T in i, u=union(D⁻¹(T))

2. Index all (u,i) pairs with an inverted index to generate the generative index I

For example, consider a target language corpus that consists of the sentence “I love sorbet” repeated 30 times. The generate n-gram process 24 will generate a corpus consisting of a single n-gram <“I love sorbet”, 30>. The identifier of this n-gram is 1. Consider an (inverse) dictionary that maps the following target language tokens to source query tokens: I→Yo, love→{amo, amos, quiero}, sorbet→sorbete. Then a single (S, T) pair is generated. That pair is ({Yo, amo, amos, quiero, sorbete}, “I love sorbet”). An inverted index is then generated on {Yo, amo, amos, quiero, sorbete} for n-gram 1. Thus, a generative index is an inverted index that indexes the inverse mapping of the tokens in the corpus.

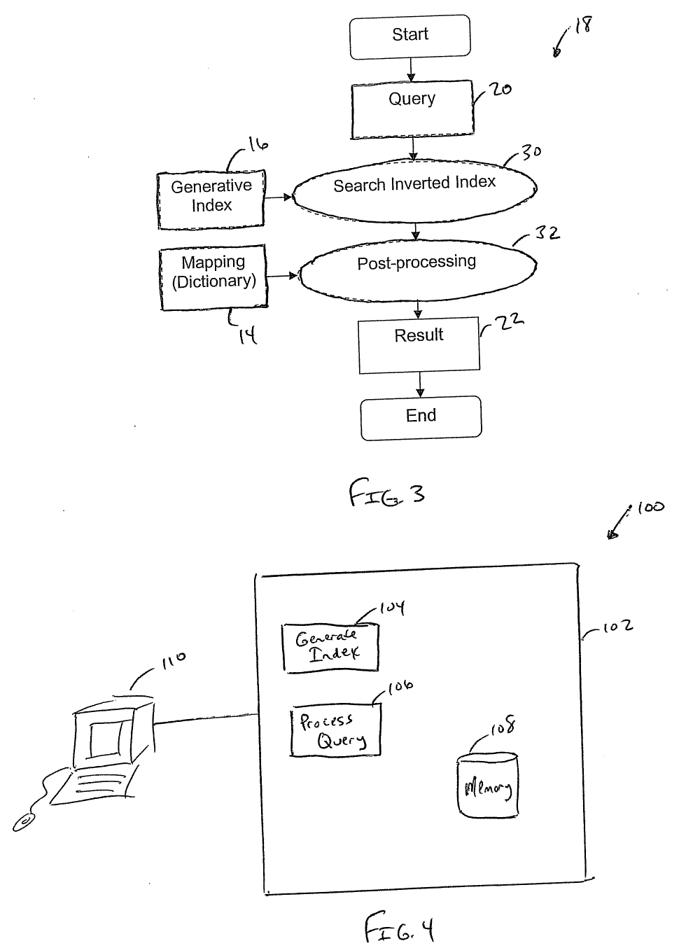

FIG. 3 illustrates a flowchart of an embodiment of the process query procedure 18 of FIG. 1. The query 20 and the generative index 16 are input to a search inverted index procedure 30. The search inverted index procedure 30 searches the generative index 16 to process the query 20. In one embodiment, the search inverted index procedure 30 intersects the set of inverted lists for each conjunct and then unions the results for each disjunction. This process consists of the following steps in one embodiment.

1. Construct parse tree of the query 20

2. Convert query 20 to disjunctive normal form tree

3. Translate disjunctive normal form tree to an operator tree

4. Execute the operator tree in a pipe-line fashion

The result of the search is a list of (u,i) pairs. In one embodiment, each (u,i) pair may be post-processed by a post-processing procedure 32 to filter out false positive matches. A false positive match occurs when query terms in a conjunct do not match one-to-one to the corresponding terms in the retrieved corpus item. Given an (u,i) pair and a query, the following steps check for false positives in one embodiment.
1. Set each disjunction (consisting of a set of conjuncts) in the query to true.
2. For each disjunction in the query, look up each conjunctive term of the disjunction in the dictionary and mark the corresponding terms in T
3. Scan T for unmarked terms. If a term is unmarked, then the corresponding conjunct is false.
4. Evaluate the query with respect to the marked disjunctions.

After the post-processing procedure 32, the result set 22 is the set of all (u,i) pairs that were retrieved during the inverted-file query processing procedure 30 and survived the post-processing check at procedure 32. In the application of generative indexes to context-based machine translation, this result set is the same of one inner step of the flooding algorithm. The flooding algorithm then takes the sequence of results and generates a translation.

For example, consider the query “Yo amo el sorbete”. The resulting Boolean query is “Yo AND amo AND sorbete”. The inverted index procedure 30 retrieves item 1<“I love sorbet” 30> because {Yo, amo, sorbete} occurs in the S portion of the (u,i) pair. The post processing procedure 32 marks “I” true from the dictionary look up of “Yo”, “love” true from the dictionary look up of “amo”, and “sorbet” true from the dictionary look-up of “sorbete”. Thus the item will survive the post-processing filtering procedure 32 and thus the item will be in the result 22.

As another example, consider the query “Yo amo amos”. The resulting Boolean query is “Yo AND amo AND amos”. The inverted index procedure 30 will retrieve item 1<“I love sorbet”, 30> because {Yo, amo, amos} all occur in the S portion of the (u,i) pair. The post processing procedure 32 marks “I” true from the dictionary look Up of “Yo”, “love” true from the dictionary look Up of “amo” and “love” true (again) from the dictionary look Up of “amos”. Thus the item will not survive post-processing filtering procedure 32 because “sorbet” is not marked. Thus the result of this query is the empty set for this example.

If the entire result set will be read, in one embodiment a performance improvement can be gained by sorting the corpus 26 according to the most likely results before the generative index 16 is constructed. This leads to a large performance improvement because the processing of results will cluster around likely results.

FIG. 4 illustrates an embodiment of a system 100 in which embodiments of the present invention may be used. As shown in FIG. 4, the system 100 includes a computer 102 that includes a generate index module 104 and a process query module 106. The computer 102 further includes a memory, such as a database or a computer readable medium 108. Input/output devices 110 are in communication with the computer 102.

Generative index trades space (and indexing time) for query processing time. The performance of a generative index of a machine translation system was measured. The corpus was a set of documents from the TIPSTER information retrieval collection. Each document in the collection was converted to lower case and then stripped of all characters outside of a-z. Table 1 lists statistics for the generative indexing process executed on the corpus. Each row of the table lists the statistics for a different n-gram size. The “source” column lists the total number of bytes produced by the n-gram generation process. The “source” (ngram) column lists the number of n-grams generated (after unique n-grams were dropped). The “index” column lists the size of the generative index. A very large and complete dictionary with 1,572,792 word translations was used. In the case that an inverse dictionary look-up generated an empty set, the corpus term itself was used. The “index” column figure includes all overhead for the Lucene inverted index. The “time” column lists the time taken to read all n-grams, augment them with inverted dictionary look-ups, and pipeline the result to the indexing engine. A single core of a 3 GHz processor constructed the index. The main result was that generative indexing, for this application domain, imposed a storage cost increase of 140/6.40=21.875 times.

TABLE 1

| | source | source | source | Index | | |
|---|---|---|---|---|---|---|
| ngrams | (bytes) | (GB) | (ngram) | (GB) | time (ms) | time (h) |
| 4 | 1,366,868,67 [symbol] | 1.27 | 43,599,308 | 26 | 29,479,016 | 8.19 |
| 5 | 1,378,284,02 [symbol] | 1.28 | 37,457,615 | 28 | 32,002,405 | 8.89 |
| 6 | 1,345,006,61 [symbol] | 1.25 | 31,477,761 | 28 | 31,717,250 | 8.81 |
| 7 | 1,362,531,27 [symbol] | 1.27 | 27,964,394 | 29 | 34,357,400 | 9.54 |
| 8 | 1,417,670,79 [symbol] | 1.32 | 25,952,895 | 31 | 37,104,419 | 10.31 |
| total | 6,870,361,37 [symbol] | 6.40 | 166,451,973 | 142 | 164,660,490 | 45.74 |

[symbol]

indicates data missing or illegible when filed

The overall strategy for query processing in context-based machine translation is broken into two steps. In the first step, a series of queries are generated from the input document. The hit list results of these queries are then saved. In the second step, the set of hit lists are sorted and then corresponding n-grams and then fetched from a sequential scan through the hit list. This optimization saves time both by increasing the cache hit rate when document blocks are read and by sequentially reading through the set of all document blocks. The series of queries generated is dynamic. Each sentence results on a slightly different set of queries depending on the results of previous queries. The method consists of the following steps:

1. For each sentence s in the document
a. For each position i in s
b. Search window(s, i, k), window(s, i, k−1) . . . until a hit list
c. Add hit list to answer a
d. Search window(s[1], i, k), window(s[2], i, k) . . . until a hit list
e. Add hit list to answer a

2. Sort a

3. Read documents associated with a

The performance of the method is measured by elapsed time from start to finish.

TABLE 2

| | | | | warm time (ms) | | | | |
|---|---|---|---|---|---|---|---|---|
| | elapsed (s) | | | | | per | count | |
| n-grams | cold | warm | dictionary | query | answer | word | query | Answer |
| 4 | 50 | 34 | 8 | 6,384 | 19,655 | 39.57 | 1,452 | 8,920,322 |
| 5 | 50 | 33 | 8 | 7,912 | 16,704 | 37.41 | 1,848 | 6,096,119 |
| 6 | 50 | 33 | 8 | 9,499 | 14,907 | 37.09 | 2,172 | 4,483,206 |
| 7 | 51 | 32 | 8 | 10,025 | 12,991 | 34.98 | 2,411 | 3,714,917 |
| 8 | 53 | 33 | 8 | 11,424 | 12,994 | 37.11 | 2,585 | 3,297,499 |

Table 2 lists the performance of various instantiations of the query method on a query document of 658 words. Each row corresponds to a different window size k of n-grams. The three elapsed time columns list the query process time for a cold-start of the system (no file system or index cache), warm start of the system, and the time required to read the dictionary at start-up. The warm elapsed query processing times are then broken down into the times taken for step 1 of the method above (the “query” column) and the times taken for steps 2 and 3 of the method above (the “answer” column). The “per word” column lists the average number of milliseconds per word. Finally, the “count” columns list the total number of queries generated and the total number of n-grams read as answers in step 3 of the method. A review of the table indicates several properties of the method. As the window size increases, the number of queries issued increases and the total time to process these queries increases. This behavior occurs because large query windows are likely to generate empty answers, forcing the search step of step 1.b and 1.d to be executed more often. Counter-balancing this effect, as the window size increases the answer sizes decreases because longer queries have smaller answer sizes. Coincidentally, these effects cancel each other out and thus the total processing time remains relatively constant, independent of window size. Note that the per-word times reported in this table are approximately 10 times faster than classical query processing time costs.

Informal sensitivity analysis is described hereinbelow. Generative indexing depends on many factors: the natural expansion factor of the dictionary, the size of the stop list, the distribution of n-grams, and the processing power and storage capacity of hosts. The expansion factor of the dictionary is approximately 20, at least among romance languages. (Asian languages are a different matter). The size of the stop list has a dramatic impact on the size of the generative index. Stop list size is generally the most sensitive variable. The distribution of n-grams has an impact because expansion ratios vary. The least sensitive variable likely is the processing power of the hosts, because this variable scales linearly with cost.

A wide variety of additional optimizations are possible. In various embodiments, the generative index is constructed incrementally, so that changes to the corpus on a periodic basis are folded into the system. The periodic changes can be done as straight transactions on the index, or merged.

Another embodiment uses a different infrastructure, such as Google map-reduce, (Hadoop) to implement all the steps. Such an architecture is scalable and offers fault tolerance properties.

Generative indexing is a general technique that applies to many areas of search such as, for example, motif search in bioinformatics, other types of search in bioinformatics, search in databases and artificial intelligence (AI) applications, search for solutions in optimization spaces, and any other application requiring search.

In various embodiments of the present invention, the generative index may be used to improve the performance of searching in bioinformatics applications. For example, a generative index may be applied to the protein to protein search problem addressed by BLAST (Altschul SF, et al., Basic Local Alignment Search Tool, Journal of Molecular Biology 215 (3): 403-410, 1990). It can be understood that generative indexes can also be used for nucleotide searches, sequence and structural motif searching for proteins or nucleotides.

In the BLAST embodiment, the target corpus is a database of protein sequences and the mapping is a dictionary of high-scoring segment pairs. When the generative index is constructed for the protein sequences, the generative index attaches high-score segments to each protein sequence, as dictated by the inverse-lookup in the mapping. Once the index is constructed, the BLAST algorithm is extended in a simple manner. Instead of scanning every sequence in the database and comparing a database sequence to the query sequence, the generative index is used to find potential matching database sequences given the query sequence in the normal inverted index manner. The results of the generative index lookup are used instead of the entire database of protein sequences. The result of the BLAST algorithm is unchanged.

Various embodiments of the present invention describe a manner in which to approach the space-time trade-off of indexing. Embodiments trade the space requirement of storage of the results of dictionary inversion for the speed improvement gained during query processing.

By way of illustration, consider the processing in a traditional setting. In a conventional setting the corpus is directly indexed. The query (not the data) is translated using a dictionary to produce a more complex query. Thus, the query “Yo amo sorbete” would be first translated (assuming a more complete dictionary) to the more complex query “I” AND (“love” OR “like”) and (“sorbet” OR “ice cream”). This query would be submitted to the inverted index.

To compare the performance, embodiments of the invention use the metric of the count the number of terms in the query (each term requires the fetch of an inverted list). The generative index approach always has the same or fewer terms in the query. Thus, the generative index approach performs better than the conventional approach on this metric.

Various embodiments of the present invention may be implemented on computer-readable media. The terms “computer-readable medium” and “computer-readable media” in the plural as used herein may include, for example, magnetic and optical memory devices such as diskettes, compact discs of both read-only and writeable varieties, optical disk drives, hard disk drives, etc. A computer-readable medium may also include memory storage that can be physical, virtual, permanent, temporary, semi-permanent and/or semi-temporary. A computer-readable medium may further include one or more data signals transmitted on one or more carrier waves.

While several embodiments of the invention have been described, it should be apparent that various modifications, alterations and adaptations to those embodiments may occur to persons skilled in the art with the attainment of some or all of the advantages of the present invention. It is therefore intended to cover all such modifications, alterations and adaptations without departing from the scope and spirit of the present invention.

What is claimed is:

1. A computer assisted method of searching at least one corpus of information based on at least one query, the method comprising:
creating a generative index based on the corpus and a mapping of terms of the query to terms of the corpus; and
searching the generative index and the corpus with the query to create a result comprising a portion of the corpus, wherein the result satisfies the query.

2. The method of claim 1, wherein the corpus of information includes a database of protein sequences and the mapping is a dictionary of high scoring protein segment pairs.

3. The method of claim 1, wherein the corpus of information includes a plurality of terms in a first language, the query includes terms in a second language, and the mapping is a dictionary.

4. The method of claim 3, wherein the first language is a target language and the second language is a source language.

5. The method of claim 1, wherein creating a generative index includes:
segmenting the corpus into sentences;
generating a plurality of n-grams for each sentence;
sorting the n-grams;
generating unique n-grams from the sorted n-grams; and
creating the generative index based on the n-grams and an inverted index.

6. The method of claim 1, wherein searching the generative index and the corpus includes:
constructing a parse tree of the query;
converting the query to a disjunctive normal form tree;
translating the normal form tree to an operator tree; and
executing the operator tree in a pipeline manner.

7. The method of claim 1, further comprising filtering out false positive matches.

8. A computer readable medium having stored thereon instructions which, when executed by a processor, cause the processor to:
create a generative index based on a corpus of information and a mapping of terms of a query to terms of the corpus; and
search the generative index and the corpus with the query to create a result comprising a portion of the corpus, wherein the result satisfies the query.

9. The computer readable medium of claim 8, wherein the corpus includes a database of protein sequences and the mapping is a dictionary of high scoring protein segment pairs.

10. The computer readable medium of claim 8, wherein the corpus includes a plurality of terms in a first language, the query includes terms in a second language, and the mapping is a dictionary.

11. An apparatus for searching at least one corpus of information based on at least one query, the apparatus comprising:
means for creating a generative index based on the corpus and a mapping of terms of the query to terms of the corpus; and
means for searching the generative index and the corpus with the query to create a result comprising a portion of the corpus, wherein the result satisfies the query.

12. The apparatus of claim 11, wherein the corpus of information includes a database of protein sequences and the mapping is a dictionary of high scoring protein segment pairs.

13. The apparatus of claim 11, wherein the corpus of information includes a plurality of terms in a first language, the query includes terms in a second language, and the mapping is a dictionary.

14. A system, comprising:
a processor; and
a computer readable medium in communication with the processor, wherein the computer readable medium has stored thereon instructions which, when executed by a processor, cause the processor to:
create a generative index based on a corpus of information and a mapping of terms of a query to terms of the corpus; and
search the generative index and the corpus with the query to create a result comprising a portion of the corpus, wherein the result satisfies the query.

15. The system of claim 14, wherein the computer readable medium comprises a database.
